(19) United States
(12) Patent Application Publication
(10) Pub. No.: US 2010/0003139 A1
(43) Pub. Date: Jan. 7, 2010

(54) PROPULSOR DEVICES HAVING VARIABLE PITCH FAN BLADES WITH SPHERICAL SUPPORT AND DAMPING SURFACES

(75) Inventor: Eric Stephen Loos, Cromwell, CT (US)

Correspondence Address: MICHAUD-DUFFY GROUP LLP, 306 INDUSTRIAL PARK ROAD, SUITE 206, MIDDLETOWN, CT, 06457, US

(73) Assignee: ROTATING COMPOSITE TECHNOLOGIES, LLC, Kensington, CT (US)

(21) Appl. No.: 12/497,862

(22) Filed: Jul. 6, 2009

Related U.S. Application Data
(60) Provisional application No. 61/078,035, filed on Jul. 3, 2008.

(51) Int. Cl. B64C 11/06

(52) U.S. Cl. 416/147

(57) ABSTRACT

A system for providing support to a fan blade of an aircraft engine includes a rotatable hub; a cradle pivotally mounted on the rotatable hub, the cradle comprising a flexible member and an adjacently positioned support member; a fan blade attached at a first end thereof to the cradle such that the flexible member engages a first surface of the fan blade at the first end of the fan blade and the support member engages a second opposing surface of the fan blade at the first end of the fan blade and such that the flexible member and the support member provide support to the fan blade relative to the rotatable hub; and means for rotating the cradle relative to the rotatable hub to vary the pitch of the fan blade. The system may include spherical support surfaces located on sides of the cradle.

### CROSS REFERENCE TO RELATED APPLICATION

This application claims the benefits of U.S. Provisional Patent Application Ser. No. 61/078,035, filed Jul. 3, 2008, the contents of which are incorporated herein by reference in their entirety.

### TECHNICAL FIELD

This invention relates to variable pitch propulsion systems and devices such as turbofans, propfans, propellers, rotors, and ducted fans. In particular, the present invention relates to systems and devices that support the fan blades of aircraft engines and provide damping thereto.

### BACKGROUND

A fan blade for use in a fan of an aircraft propulsion system generally comprises an airfoil mounted to a base. A dovetail joint at the root of the fan blade typically fixedly attaches the fan blade to a rotatable hub and provides stiffness and support. This method of retaining a fan blade utilizes a large metal disk as the rotatable hub with multiple dovetail slots to accept each fan blade. The spacing of dovetail slots makes for a large, heavy centerbody portion of the fan.

Rotation of the hub is typically effected by a work-producing device such as a high speed turbine, which may be driven by any suitable means. As the hub rotates, the fan blades are likewise rotated and produce thrust. When attached to an aircraft, the thrust provides propulsion for forward momentum.

The fan blades may be movably attached to the hub to provide variable pitch. Variable pitch allows the pitch of the fan blades to be changed to absorb different amounts of power from the work-producing device based on flight conditions. Methods of accomplishing pitch change usually include a root attachment mechanism that allows for rotation of the blades about an axis that is longitudinal to the blade and orthogonal to the base. Such root attachment mechanisms include ball/roller bearing combinations. Races in which such bearing combinations are housed can be large and heavy due to the high blade centrifugal forces encountered in a rotating fan. The large size provides the blade with bending support as well as stiffness to help keep the natural frequencies of the system adequately high to avoid resonance and flutter.

In some applications, variable pitch can be accomplished by making use of circular blade retention bearings. The size of the bearing is related to its ability to provide centrifugal load support and blade bending support. Circular ball bearings can be adequately stiff to support a fan blade; however, that stiffness comes at the cost of bearing diameter. The circular bearings nest together is such a way that the resulting centerbody portion of the fan becomes impracticably large and heavy.

Flexible retention elements can also be used in variable pitch systems. When flexible retention elements are used to provide for variable pitch and fan blade retention, reductions in weight are realized. Also, flexible retention elements are generally compact and can nest together to reduce the size of the centerbody portion of the fan.

In either instance, centrifugal loads on plate-like structures associated with the blades produce twisting forces that pitch control systems overcome. These forces tend to rotate the blade towards a flat pitch position, such that a malfunction in pitch control could result in rotor overspeed and potential blade loss.

The force used to change the pitch angle of a rotating blade can be appreciable. This force is usually referred to as the Total Twisting Moment (TTM), which is the net sum of three basic forces. The first is Centrifugal Twisting Moment (CTM) that originates from the non-symmetrical mass distribution of a blade's airfoil about its pitch change axis. The second is Aerodynamic Twisting Moment (ATM) caused when the effective center of pressure on each airfoil section is aligned forward or aft of the pitch change axis and that airload causes a twisting load about the blade pitch axis. The third is Frictional Twisting Moment (FTM) which resists motion and develops in the retention bearings that support the blade, due to high centrifugal loads acting on them. Among these, CTM is by far the greatest, with ATM and FTM distant seconds. CTM acts to rotate a blade toward low pitch. Because the aerodynamic center of pressure of an airfoil of a blade is usually forward of its pitch change axis, ATM normally acts to increase blade pitch, opposing CTM. FTM, which is caused by friction, acts to oppose blade pitch change in either direction.

With TTM being dominated by CTM, a pitch control system exerts a twisting load in the direction of increased pitch to hold blade pitch constant, and a higher force yet to overcome FTM in order to increase blade pitch. If there is a malfunction and/or loss of control of the pitch system, a blade will naturally turn toward low pitch. Because low blade pitch results in less rotational resistance for the engine, the situation can result in an overspeed of the rotor and engine, thereby possibly resulting in a loss of engine power. Loss of engine power is usually accompanied by loss of pitch control. Again TTM can turn the blades to low pitch, but rotor thrust suddenly switches to a high drag force that can cause possible loss of aircraft control and/or result in rotor overspeed. Rotor overspeed is more likely if the rotor is driven by a turbine engine rather than a piston engine, especially if the former has a “free” turbine that powers the rotor. When the number of blades in the fan is great, loss of pitch control and the turning of blades to low pitch could cause significant drag and overspeed conditions. Therefore, backup pitch-change systems, pitch safety latches, or other complicated, expensive and/or heavy solutions have not been attractive to date.

To prevent undesirable change in pitch tendencies, the conventional solution is to add a counter-weight to the side of a blade at/near its root end to support and provide damping action to the blade. This weight has sufficient mass and position to create a net TTM that overcomes the inherent blade twist loads and drives the blade towards high pitch, or at least holds pitch setting to prevent movement toward low pitch. The counter-weight mass on each blade is normally quite substantial and adds undesirable weight to the rotor, as well as additional load to the rotor hub and blade retention bearings. Also, there is the added risk of failure of a counter-weight support arm, possible impact damage if the weight strikes the aircraft fuselage, combined with dangerous unbalance of the rotor.

### SUMMARY

In one aspect of the present invention, a system for providing support to a fan blade of an aircraft engine comprises a rotatable hub; a cradle pivotally mounted on the rotatable hub, the cradle comprising a flexible member and an adjacently positioned support member; a fan blade attached at a first end thereof to the cradle such that the flexible member engages a first surface of the fan blade at the first end of the fan blade and the support member engages a second opposing surface of the fan blade at the first end of the fan blade and such that the flexible member and the support member provide support to the fan blade relative to the rotatable hub; and means for rotating the cradle relative to the rotatable hub to vary the pitch of the fan blade.

In another aspect of the present invention, a system for providing support to a fan blade of an aircraft engine comprises a rotatable hub; a cradle pivotally mounted on the rotatable hub, the cradle comprising a flexible member and an adjacently positioned support member to define a cavity therebetween; a fan blade attached at a first end thereof to the cradle such that the flexible member engages a first surface of the fan blade at the first end of the fan blade and the support member engages a second opposing surface of the fan blade at the first end of the fan blade and such that the flexible member and the support member provide support to the fan blade relative to the rotatable hub; a first support surface located on a first side of the cradle; a second support surface located on a second opposing side of the cradle; and means for rotating the cradle relative to the rotatable hub to vary the pitch of the fan blade. The first support surface and the second support surface respectively engage adjacently-positioned support surfaces on adjacently-positioned cradles.

### BRIEF DESCRIPTION OF THE DRAWINGS

FIG. 1 is a perspective view of a portion of a fan blade.

FIG. 2 is a perspective view of a portion of the fan blade of FIG. 1 showing a cradle in which a blade is mounted.

FIG. 3 is a front view of the fan of FIG. 1 showing the interaction of spherical support surfaces supporting the blades.

### DESCRIPTION OF INVENTION

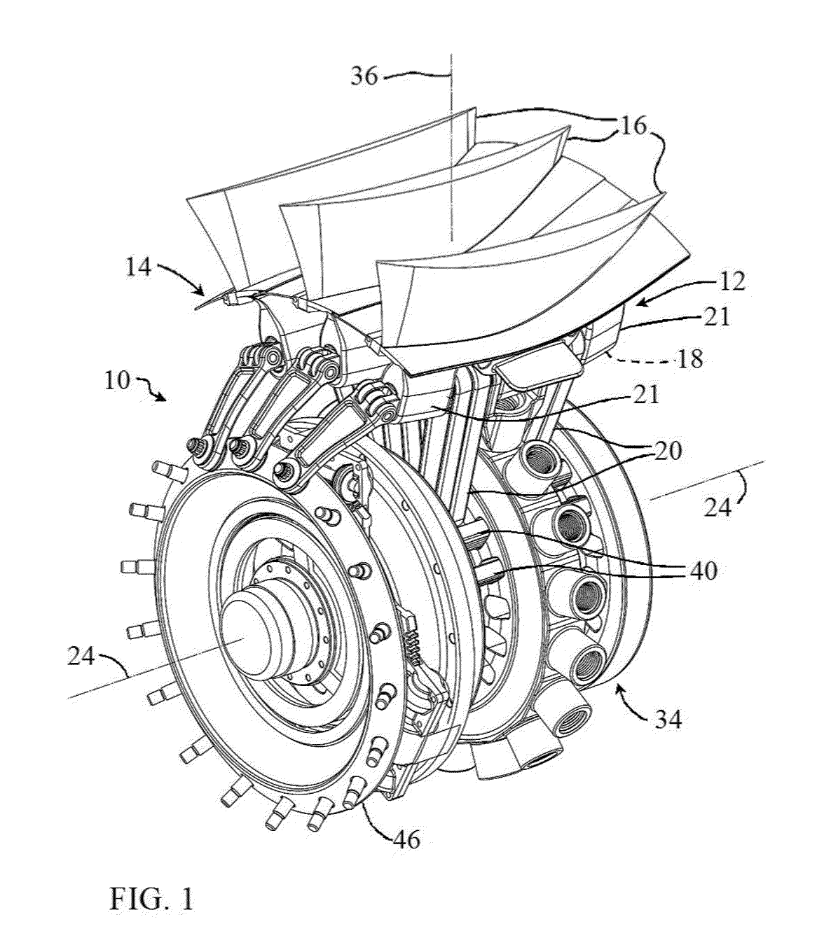

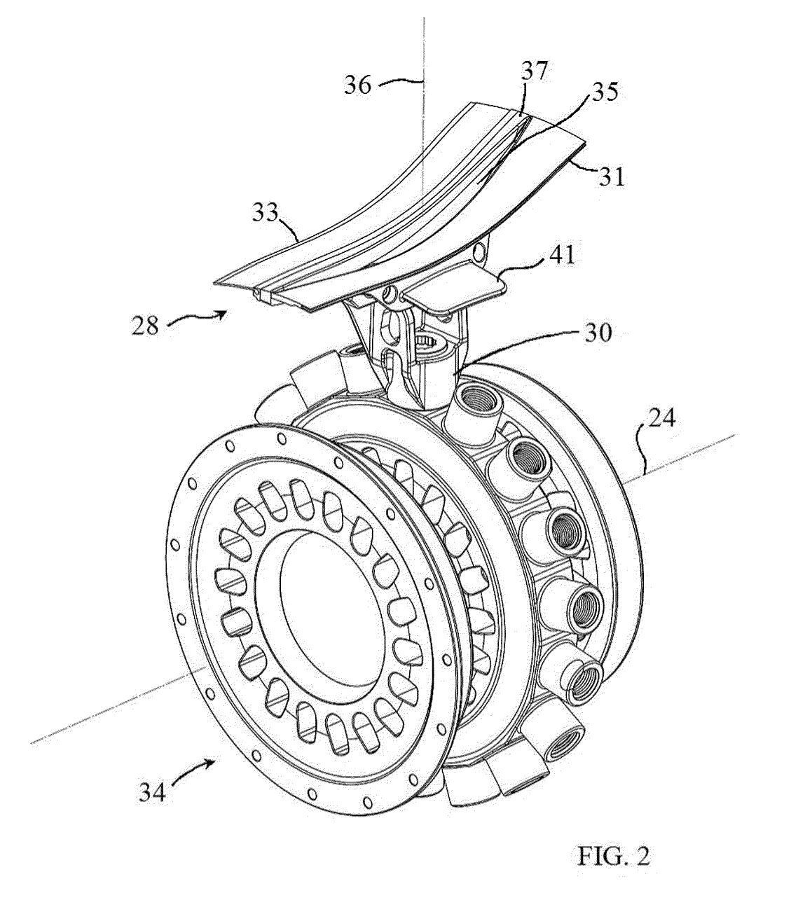

Referring to FIGS. 1 and 2, a fan capable of effecting a variable pitch of a fan blade is shown generally at 10. The fan 10 defines a system that retains a fan blade having a pin root portion 12 as one possible means of attachment to a central hub 34. The pin root portion 12 is inboard of a centerbody airflow path 14 and includes a blade 16 having three blade tennons 21 extending therefrom wrapping around a pin 18. The three blade tennons 21 define spaces therebetween for accommodating at least two flexible support tennons 20 arising from the hub 34. In this embodiment, the hub 34 is located on a centerline 24 of the fan 10. At least two flexible support tennons 20 are attached to the pin 18 in the spaces between the three blade tennons 21. These support tennons 20 extend further inward and attach to the central hub 34, each support tennon 20 able to pivot or flex in such a way as to help balance the CTM and ATM forces of the blades 16.

The flexible support tennons 20 are of sufficient length and inherent flexibility to permit an acceptable amount of angular rotation of the common pin 18 supporting the blade 16. The root of the blade 16 is attached to a pivotally-mounted cradle-shaped component (cradle 28) that incorporates a clevis 30 mounted over a post or other similar feature of the central hub 34, establishing an axis 36 about which blade pitch rotation occurs. These support tennons 20 provide a means of supporting the blade 16 and introduce some torsional resistance. In addition to the flexible support tennons 20, the clevis 30 and hub post can offer a secondary means of retaining the blade 16 and cradle 28 (e.g., via the use of a bolt, fastener, security retainer, or the like, which may be threaded). The pin root blade design, in combination with the added support capacity of the tennons and clevis 30, provides some support to the blade 16 and also provides an added measure of safety in the event of an accidental incident such as impact with foreign objects (large birds or runway debris) where blade bending loads resulting from impact can be many times as great as normal operating forces.

The use of at least two support members 40, offset or angled relative to one another, counteracts the natural TTM tendency of the blade 16 that turns it toward low pitch and provides some support to the blade 16. In its simplest form, the inboard end or root part of these two support tennons 20 can be fixed efficiently to the central hub 34 with two separate support members 40. Should loss of pitch control occur and/or loss of engine power, a desired pitch setting can be obtained by spatial placement of the support tennon 20 attachment points in the central hub 34. The placement would be biased such that blade TTM, affected by high centrifugal tension loads on two support paths instead of one, remains balanced and/or moves to a desirable setting(s) for any given rotor speed(s) or flight condition, such as cruise.

In the fan 10, blade angular pitch change is accomplished by use of a timing mechanism or timing ring 46 that is located on the front of the hub 34 and operably connected to the hub 34 via pitch arms 74. The timing ring 46 rotates with the hub 34 but is controllably rotatable relative to the hub 34 to cause the pitch arms 74 to rotate the cradles 28 (and thereby the blades 16) about the axis 36, thereby changing the pitch of the blades 16. The present invention is not limited in this regard, as other devices used to effect blade pitch change are within the scope of the present disclosure.

Referring now to FIG. 2, the cradle 28 comprises a first outer support member 31 and a second outer support member 33. A flexible member 37 is positioned adjacent the second outer support member 33 such that the flexible member 37 and the first outer support member 31 define a blade cavity 35. The flexible material of the flexible member 37 and the first out support member 31 nestles the root portion of the blade 16 therebetween and can cushion the blade 16 during a bird strike as well as offer damping effects against vibration and flutter. The blade 16 is mounted to the hub 34 using the blade tennons 21, the pin 18, and the support tennons 20 while a lower portion of the blade 16 is supported by the flexible member 37 and the first outer support member 31 at opposing sides of the blade 16. The present invention is not limited in this regard, as a flexible member can be positioned on each side of the blade.

Referring back to both FIGS. 1 and 2, the fan 10 also includes spherical support surfaces 41 located on opposing sides of each cradle 28. The spherical support surfaces 41 allow for a compact and consistent support surface through the range of pitch change while increasing the stiffness, reliability, and operational safety of the fan 10. The blade 16 is stabilized and stiffened relative to other blades by the adjacent blades, which results in a system where the foundation stiffness of all of the blades 16 in the fan 10 increase enough to resist bending loads and raise natural frequencies to acceptable levels.

When the fan 10 is assembled with the blades 16, the spherical support surface 41 of one blade 16 supports an adjacent spherical support surface 41 of an adjacent blade 16, thereby increasing the foundation stiffness of each blade 16 yet still providing a flexible attachment point. Implementing the spherical support surfaces 41 described herein takes advantage of the benefits of variable pitch using the flexibility of the support tennons 20 without compromising the structural stability of the fan 10.

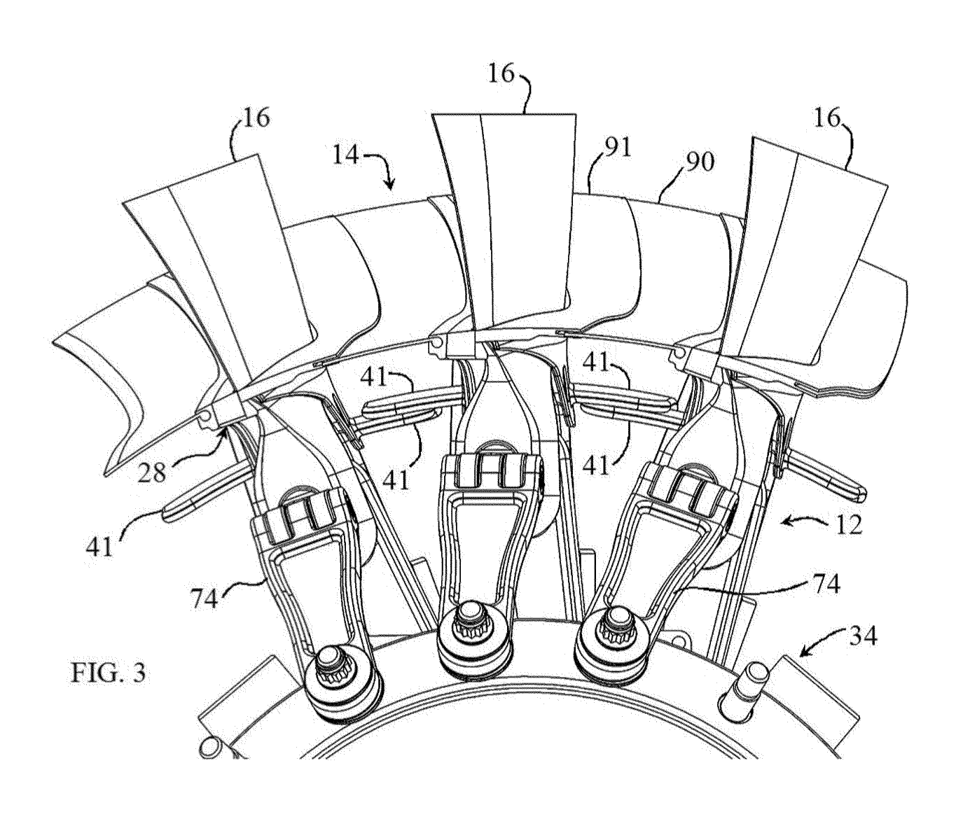

Referring now to FIG. 3, the spherical support surfaces 41 of one blade 16 maintain contact with adjacent spherical support surfaces 41 of the adjacent blades 16 as the blades change pitch. The contact is maintained due to the spherical geometry of the spherical support surfaces 41. More specifically, an upper surface of one spherical support surface 41 engages a lower surface of an adjacent spherical support surface 41. Upon movement of the blades 16 (e.g., in a pitch change operation), one spherical support surface 41 slides against the spherical support surface 41 of the adjacent blade 16. The spherical support surfaces 41 may be preloaded at the time of assembly of the fan 10 to insure the desired amount of support in all operating conditions of the fan 10.

Friction between the spherical support surfaces 41 is overcome to change blade pitch. This friction is also overcome in order for the blades 16 to flutter or otherwise vibrate. Therefore, friction between the spherical support surfaces 41 is acting as a damper to oscillatory movement. Increasing or decreasing the designed friction between the surfaces can help achieve more or less damping.

The incorporation of the spherical support surfaces 41 into the fan 10 facilitates the addition of support and stiffness to a variable pitch system with flexible strap retention elements (e.g., the support tennons 20 as shown in FIG. 1). One way of achieving this is by applying a cushioning support using the spherical support surfaces 41 to the base of the blade. The use of a spherical support surface 41 allows for consistent support through the pitch range of the fan 10. The center of the spherical support surface 41 is located at the intersection of the pitch change axis of the blade and the rotational axis of the fan. Executing this design allows the blade 16 to change pitch without changing the location of the spherical support surface 41, thus allowing for consistent damping and support between blades 16 through the pitch range.

Still referring to FIG. 3, a centerbody airflow path 14 is defined above the pin root portion 12 and in the spaces between the blades 16. The cradles 28 on which the blades 16 are located are connected to adjacent cradles by platforms 90 and 91. A platform 90 is connected to the cradle 28 by engaging one edge 92 thereof in a J-slot 94 located on a corresponding edge of the cradle. An opposing edge 95 of the platform 90 engages a slot in adjacent platform 91, which is connected to the cradle 28 simultaneously with the mechanisms by which the blade is connected to the cradle 28. The spherical support surfaces 41 are located beneath the platforms 90 and 91. A nosecone or similar apparatus (not shown) is fitted over the central hub 34 such that an edge thereof is positioned at a forward edge of the platforms 90 and 91.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the following claims.

What is claimed is:

1. A system for providing support to a fan blade of an aircraft engine, the system comprising:
a rotatable hub;
a cradle pivotally mounted on the rotatable hub, the cradle comprising a flexible member and an adjacently positioned support member to define a blade cavity;
a fan blade attached at a first end thereof to the cradle such that the flexible member engages a first surface of the fan blade at the first end of the fan blade and the adjacently positioned support member engages a second opposing surface of the fan blade at the first end of the fan blade and such that the flexible member and the support member provide support to the fan blade relative to the rotatable hub; and
means for rotating the cradle relative to the rotatable hub to vary the pitch of the fan blade.

2. The system of claim 1, wherein the cradle is pivotally mounted on a post located on the rotatable hub.

3. The system of claim 2, further comprising flexible tennons connecting the fan blade to the rotatable hub.

4. The system of claim 1, wherein the cradle further comprises a support member flanking the flexible member and providing support to the flexible member and the fan blade.

5. The system of claim 1, further comprising a first spherical support surface located on a first side of the cradle and a second spherical support surface located on a second opposing side of the cradle.

6. The system of claim 5, wherein the first spherical support surface and the second spherical support surface engage adjacently-positioned spherical support surfaces on adjacently-positioned cradles, and wherein such engagement provides friction between the engaged spherical support surfaces.

7. A system for providing support to a fan blade of an aircraft engine, the system comprising:
a rotatable hub;
a cradle pivotally mounted on the rotatable hub, the cradle comprising a flexible member and an adjacently positioned support member defining a cavity therebetween;
a fan blade positioned in the cavity and attached at a first end thereof to the cradle such that the flexible member engages a first surface of the fan blade at the first end of the fan blade and the support member engages a second opposing surface of the fan blade at the first end of the fan blade and such that the flexible member and the support member provide support to the fan blade relative to the rotatable hub;
a first support surface located adjacent on a first side of the cradle;
a second support surface located on a second opposing side of the cradle; and
means for rotating the cradle relative to the rotatable hub to vary the pitch of the fan blade;
wherein the first support surface and the second support surface respectively engage adjacently-positioned support surfaces on adjacently-positioned cradles.

8. The system of claim 7, wherein the cradle is pivotally mounted on a post located on the rotatable hub.

9. The system of claim 8, further comprising flexible tennons connecting the fan blade to the rotatable hub.

10. The system of claim 7, wherein the first support surface located on the first side of the cradle and the second support surface located on the second opposing side of the cradle are spherical.
